(19) United States
(12) Patent Application Publication
(10) Pub. No.: US 2018/0192431 A1
(43) Pub. Date: Jul. 5, 2018

(54) TECHNIQUES FOR FULL DUPLEX WIRELESS COMMUNICATIONS

(71) Applicants: PING WANG, SANTA CLARA, CA (US); SHU-PING YEH, NEW TAIPEI CITY (TW); ALEXANDER W. MIN, PORTLAND, OR (US); YANG-SEOK CHOI, PORTLAND, OR (US)

(72) Inventors: PING WANG, SANTA CLARA, CA (US); SHU-PING YEH, NEW TAIPEI CITY (TW); ALEXANDER W. MIN, PORTLAND, OR (US); YANG-SEOK CHOI, PORTLAND, OR (US)

(21) Appl. No.: 15/394,544

(22) Filed: Dec. 29, 2016

(51) Int. Cl. H04W 72/12; H04L 5/14; H04W 28/02

(52) U.S. Cl. CPC H04W 72/1221; H04W 72/1231; H04W 28/0278; H04L 5/14

(57) ABSTRACT

Various embodiments may be generally directed to full duplex (FDX) communications on a wireless channel. More specifically, in various embodiments described herein, FDX communications may occur on a wireless channel between a FDX capable device, such as an access point (AP), and two or more half-duplex (HDX) capable devices, such as a plurality of stations (STAs). For instance, the AP may transmit information to a first station (STA) via a wireless channel at the same time as receiving information from a second STA via the wireless channel. In some embodiments, the AP may arrange the FDX communications.

### BACKGROUND

A duplex communication system may be a point-to-point system comprising two devices that can communicate with each other over a connection in both directions. Generally, a duplex system may be categorized as either a full duplex (FDX) system or a half-duplex (HDX) system. Typically, in a full duplex system, both devices may simultaneously communicate in both directions. On the other hand, in a half-duplex system, typically, devices may only communicate in one direction at the time. For instance, each device may take turns at either transmitting to the other device as the other device receives or receiving from the other device as the other device transmits.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a first communications flow.

FIG. 4 illustrates an embodiment of a second communications flow.

FIG. 5 illustrates an embodiment of a third communications flow.

FIG. 6 illustrates an embodiment of a fourth communications flow.

FIG. 7 illustrates an embodiment of a fifth communications flow.

FIG. 8 illustrates an embodiment of a sixth communications flow.

FIG. 9A illustrates an embodiment of a seventh communications flow.

FIG. 9B illustrates an embodiment of an eighth communications flow.

FIG. 10 illustrates an embodiment of a first logic flow.

FIG. 11 illustrates an embodiment of a second logic flow.

FIG. 12 illustrates an embodiment of a storage medium.

FIG. 13 illustrates an embodiment of a device.

FIG. 14 illustrates an embodiment of a wireless network.

### DETAILED DESCRIPTION

Various embodiments may be generally directed to full duplex (FDX) communications on a wireless channel. More specifically, in various embodiments described herein, FDX communications may occur on a wireless channel between a FDX capable device, such as an access point (AP), and two or more half-duplex (HDX) capable devices, such as a plurality of stations (STAs). For instance, the AP may transmit information to a first station (STA) via a wireless channel at the same time as receiving information from a second STA via the wireless channel. In some embodiments, the AP may arrange the FDX communications. In one embodiment, for example, an apparatus may comprise logic for an access point (AP), at least a portion of the logic implemented in circuitry coupled to the memory, the logic to determine to send a downlink (DL) transmission via a wireless channel to a first station (STA), identify a second STA with an uplink (UL) transmission in queue for transmission to the AP, and schedule the AP, the first STA, and the second STA to utilize the wireless channel for full duplex (FDX) communication in a time interval. Other embodiments are described and claimed.

Some embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Various embodiments herein are generally directed to wireless communications systems. Various embodiments are particularly directed to wireless communications performed according to one or more wireless communications standards. Some embodiments may involve wireless communications performed according to High-Efficiency Wi-Fi standards developed by the IEEE 802.11 High Efficiency WLAN (HEW) Study Group. Various embodiments may involve wireless communications performed in accordance with an Institute of Electrical and Electronics Engineers (IEEE) 802.11ax standard. Some embodiments may involve wireless communications performed in accordance with the DensiFi Specification Framework Document (SFD). The embodiments are not limited in this context.

Some embodiments may additionally or alternatively involve wireless communications according to one or more other wireless communication standards. Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

Further examples of wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11af, IEEE 802.11ah, and/or IEEE 802.11ay standards, High-Efficiency Wi-Fi standards developed by the IEEE 802.11 High Efficiency WLAN (HEW) Study Group and/or IEEE 802.11 Task Group (TG) ax, Wi-Fi Alliance (WFA) wireless communication standards such as Wi-Fi, Wi-Fi Direct, Wi-Fi Direct Services, WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above. The embodiments are not limited to these examples.

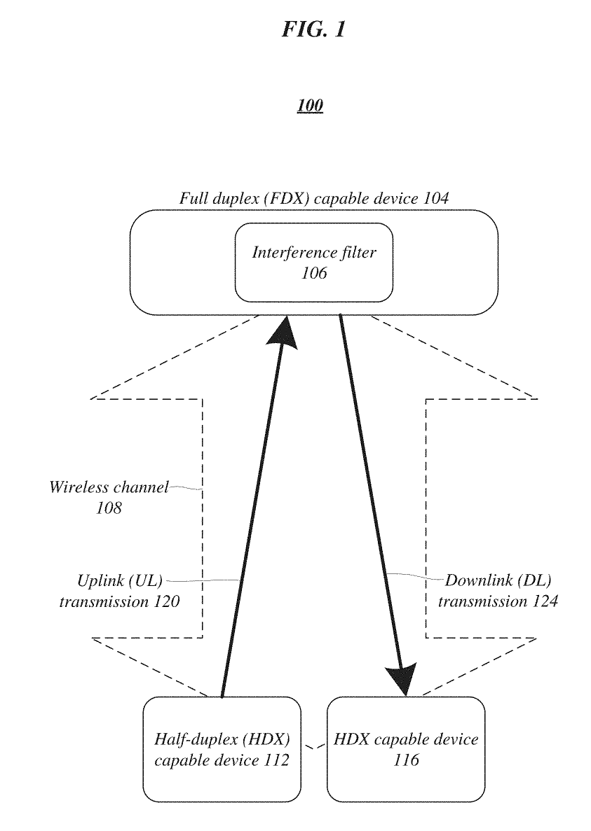

FIG. 1 illustrates an example of an operating environment 100 that may be representative of various embodiments. In operating environment 100, a full duplex (FDX) capable device may simultaneously communicate with half-duplex (HDX) capable device 112 and HDX capable device 116 over wireless channel 108. In various embodiments, the simultaneous communication between FDX capable device 104 and HDX capable devices 112 and 116 may be referred to as FDX communication, joint UL-DL transmissions, and/or FDX transmissions. For instance, FDX communication may occur on wireless channel 108 when FDX capable device 104 simultaneously receives an uplink (UL) transmission 120 from a first HDX capable device, such as HDX capable device 112, and transmits a downlink (DL) transmission 124 to a second HDX capable device, such as HDX capable device 116. FDX communication may enable more efficient use of the wireless channel 108, such as by increasing throughput. In some embodiments, HDX capable device 104 may include interference filter 106 to enable FDX capable device 104 to simultaneously transmit and receive information. Embodiments are not limited in this context.

In various embodiments, interference filter 106 may enable FDX capable device 104 to prevent wireless signals from interfering with simultaneously transmitting and receiving wireless signals. For example, interference filter 106 may suppress a transmission echo of FDX device 104. Thus, FDX capable device 104 may be able to decode data received via wireless channel 108 even when the wireless channel 108 is being simultaneously used for transmission. In some embodiments, preventing interference may enable joint UL-DL transmissions 120, 124 between FDX capable device 106 and HDX capable device 112, 116. In various embodiments, interference filter 106 may include one or more hardware and/or software components that operate to identify and remove interference signals in received communications. For instance, interference filter 106 may utilize one or more algorithms to identify and remove noise from received transmissions.

In some embodiments FDX capable device 104 may be a node in a network. In some such embodiments, FDX capable device 104 may be an access point (AP) in the network. For example, FDX capable device 104 may be an AP that is a personal basic service set (PBSS) control point (PCP). In various embodiments, FDX capable device 104 may enable one or more aspects or functionalities of a network, such as FDX communication on wireless channel 108. In various embodiments, HDX capable devices 112 and 116 may also be nodes in the network. For instance, HDX capable device 112 may include a first station (STA) and HDX capable device 116 may include a second STA. In various embodiments described herein, FDX capable device 106 may perform one or more functions to facilitate FDX communication in a network on wireless channel 108 using HDX capable devices 112 and 116. For example, FDX capable device 104 may select HDX capable device 112 and/or HDX capable device 116 from a plurality of HDX capable device that are nodes in the network to pair for joint UL-DL transmissions 120, 124 on wireless channel 108.

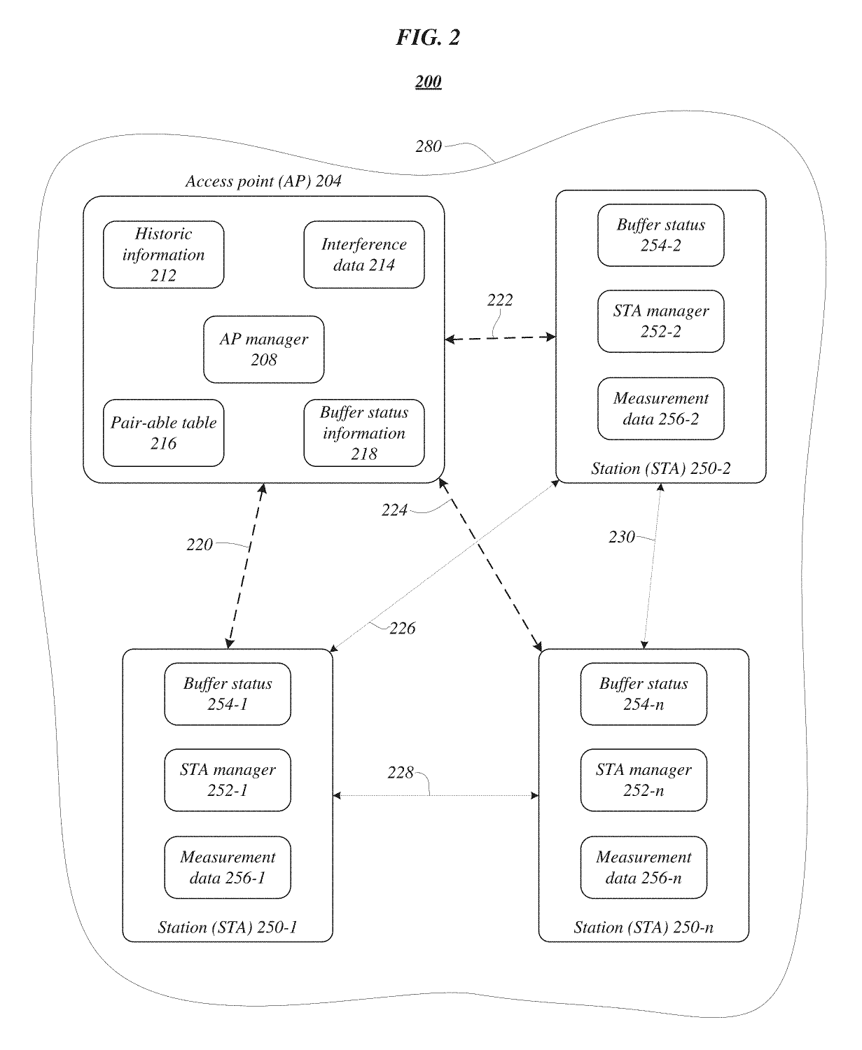

FIG. 2 illustrates an embodiment of an operating environment 200 that may be representative of operations one or more of AP 204, STA 250-1, STA 250-2, and STA 250-n may perform in various embodiments to enable FDX communication, such as on a wireless channel. In operating environment 200, AP 204 and STAs 250-1, 250-2, 250-n may be nodes in wireless network 280 that interact to identify STAs that can be paired together to engage in FDX communication with AP 204. In various embodiments, AP 204 may be the same or similar to FDX capable device 104 and STAs 250-1, 250-2, 250-n may be the same or similar to one or more of HDX capable devices 112 and 116. In some embodiments, one or more of AP 204 and STAs 250-1, 250-2, 250-n may perform one or more operations to establish, support, schedule, and/or manage FDX communication in wireless network 280. In various embodiments described herein, AP 204 may determine at least one of two STAs (e.g., STAs 250-1 and 250-2) pair for FDX communication on a wireless channel with AP 204, such as in a joint UL-DL transmission. In various such embodiments, AP 204 may use one or more characteristics of one or more nodes in wireless network 280 to determine which STAs to pair for FDX communication. In some embodiments, the one or more characteristics of nodes in wireless network 280 may include one or more of capability, performance, traffic, settings, hardware, software, and the like. Embodiments are not limited in this context.

In various embodiments, one or more nodes in wireless network 280 may be communicatively coupled with each other. For instance, a joint UL-DL transmission may include an UL transmission from STA 250-1 to AP 204 via communication link 220 that at least partially overlaps a DL transmission from AP 204 to STA 250-2 via communication link 222. In some embodiments, any combination of AP 204, first STA (e.g., STA 250-1), and second STA (e.g., STA 250-2) may be utilized in joint UL-DL transmission during FDX communication. In many embodiments, FDX communication, such as via joint UL-DL transmission (i.e., FDX transmission), may improve the efficiency and throughput of wireless network 280. In various embodiments, wireless network 280 may operate according to IEEE 802.11ax. In some embodiments, any combination of one or more APs (e.g., AP 204, same or similar AP) and one or more STAs (e.g., STAs 250-1, 250-2, 250-n) may be utilized to improve network performance (e.g., wireless network 280). For instance, participants and parameters of the FDX communication may be dynamically varied to maximize network performance. It will be appreciated that communication links 220, 222, 224, 226, 228, 230 may not necessarily imply that a transmission is directional or private, instead, the links are only used to illustrate that information may be communicated between the two endpoints in wireless network 280. For instance, a transmission via communication link 220 from AP 204 to STA 250-1 may include a transmission that is broadcast over wireless network 280, and thus may also be received by one or more of STA 250-2 and STA 250-n.

In some embodiments joint UL-DL transmissions may occur according to one or more of a destination-based joint DL-UL transmission strategy and a source-based joint DL-UL transmission strategy. In various embodiments, one or more of the strategies may be used. In a destination-based joint DL-UL strategy, a STA may win contention of channel access for a UL transmission and an AP may initiate full duplex downlink (FD-DL) transmission afterwards. In some embodiments, using a destination-based joint DL-UL strategy, a first STA with a UL transmission queued to send to an AP may win contention of channel access and, in response, the AP may identify a DL transmission queued to send to a second STA. In some such embodiments, at least a portion of the UL transmission and the DL transmission may occur simultaneously on the same wireless channel. In a source-based joint DL-UL strategy, an AP may win contention of channel access for a DL transmission to a STA and trigger/poll another STA for full duplex uplink (FD-UL) transmission. In various embodiments, in a source-based joint DL-UL strategy, an AP with a DL transmission queued to send to a first STA may win contention of channel access and, in response, the AP may trigger or poll a second STA to send an UL transmission to the AP. In various such embodiments, at least a portion of the UL transmission and the DL transmission may occur simultaneously on the same wireless channel.

In operating environment 200, AP 204 may be communicatively coupled with STA 250-1 via communication link 220, STA 250-2 via communication link 222, and STA 250-n via communication link 224. STA 250-1 may further be communicatively coupled with STA 250-2 via communication link 226 and STA 250-n via communication link 228. STA 250-2 may further be communicatively coupled with STA 250-n via communication link 230. Thus, in the illustrated embodiment, each node can directly communicate with any other node in wireless network 280. In various embodiments, communication between different nodes in wireless network 280 may include transmission of one or more frames. In some embodiments described herein, the various communication links in operating environment 200 may enable FDX communication to be coordinated and/or realized between AP 204 and two STAs, such as STAs 250-1 and 250-2. For instance, AP manager 208 may schedule a joint UL-DL transmission with AP 204, STA 250-1, and STA 250-2. In various embodiments, the use of “-n” in STA 250-n may indicate that wireless network 280 may include a varying and/or arbitrary number of STAs. In various such embodiments, STAs 250-1 and 250-2 maybe identified as a pair out of any number of available STAs based one or more characteristics of one or more nodes or features of wireless network 280.

In the illustrated embodiment, AP 204 may include AP manager 208, historic information 212, interference data 214, pair-able table 216, and buffer status information 218. In various embodiments, AP manager 208 may utilize one or more of historic information 212, interference data 214, and buffer status information 218 in the generation and management of pair-able table 216. In some embodiments, one STA (e.g., STA 250-1) could transmit an uplink or downlink sounding signal for the potential pair-able STAs (e.g., STA 250-2 and STA 250-n) to measure it and then feedback to AP 204 to help AP 204 generate pair-able table 216. In some embodiments, pair-able table 216 may include one or more indications of STAs that may be paired to engage in FDX communication with AP 204. The pair-able table 216 may include a ranking of potential pairs, such as according to a priority level or one or more preferences, in various embodiments. Some embodiments may include the same, different, and/or additional data to support FDX communications. In some such embodiments, one or more nodes in wireless network 280 may measure, store, trigger, and/or communicate any data useful in supporting FDX communications. In various embodiments, AP manager 208 may use pair-able table 216 to identify a second STA to perform a UL transmission in response to determining to perform a DL transmission to a first STA. In some embodiments, AP manager 208 may use pair-able table 216 to identify a second STA to send a DL transmission to in response to determining to receive a UL transmission from a first STA. In various embodiments, using one or more characteristics associated with one or more nodes of wireless network 280 to generate pair-able table 280 may enable higher throughput and/or better efficiency in wireless network 280.

In some embodiments, AP manager 208 may store one or more characteristics associated with one or more nodes of wireless network 280 in one or more of historic information 212, interference data 214, and buffer status information 218. In various embodiments, AP 204 may utilize the data to support FDX communications. In various such embodiments, AP 204 may request or receive the one or more characteristics associated with one or more nodes of wireless network 280. In the illustrated embodiment, respective STA managers 254-1, 524-2, 254-n may respond for respective STAs 250-1, 250-2, 250-n. In some embodiments, one or more nodes in wireless network 280 may measure one or more characteristics associated with themselves or one or more other nodes in wireless network 280. For example, STA 250-1 may measure interference caused by STA 250-1. In another example, AP 204 may request that STA 250-1 measure interference caused by STA 250-2. In the illustrated embodiment, respective STA managers 254-1, 524-2, 254-n may enable and/or perform the measurements for respective STAs 250-1, 250-2, 250-n.

Historic information 212 may include data that associates one or more characteristics with one or more STAs and/or APs. In some embodiments interference data 214 and buffer status information 218 may be included in historic information 212. In various embodiments, historic information 212 may be gathered or requested by AP 204. Interference data 214 may include UL-STA to DL-STA interference. In some embodiments, interference data 214 may be determined by having one or more STAs measure interference as another STA transmits a signal. AP 204 may then receive indications of the interference from the one or more measuring STAs (e.g., measurement data 256-1, 256-2, and/or 256-n) and store the indications as interference data 214. Buffer status information 218 may include a queue status of one or more STAs. For instance, when STAs have data for a UL transmission, the STAs may include an indication of this in respective buffer statuses 254-1, 254-2, 254-n. In some embodiments, AP 204 may request buffer status reports from one or more STAs 250-1, 250-2, 250-n and store indications of one or more STA's buffer status in buffer status information 218. In various embodiments AP manager 208 may utilize one or more of historic information 212, interference data 214, buffer status information, 218 to generate, maintain, or update pair-able table 216. In various such embodiments, AP manager 208 may pair STAs to participate in FDX communication with AP 204 based on pair-able table 216.

In various embodiments, one or more of AP manager 208, STA manager 252-1, STA manager 252-2, and STA manager 252-n may comprise or refer to logic that enables one or more functionalities of respective devices (i.e., AP 204, STAs 250-1, 250-2, 250-n). For example, managers 208, 252-1, 252-2, 252-n may generate and interpret frames used to wirelessly send information over one or more of communication links 220, 222, 224, 226, 228, 230. However, it will be appreciated that any combination of hardware and/or software may be used to realize one or more embodiments described herein.

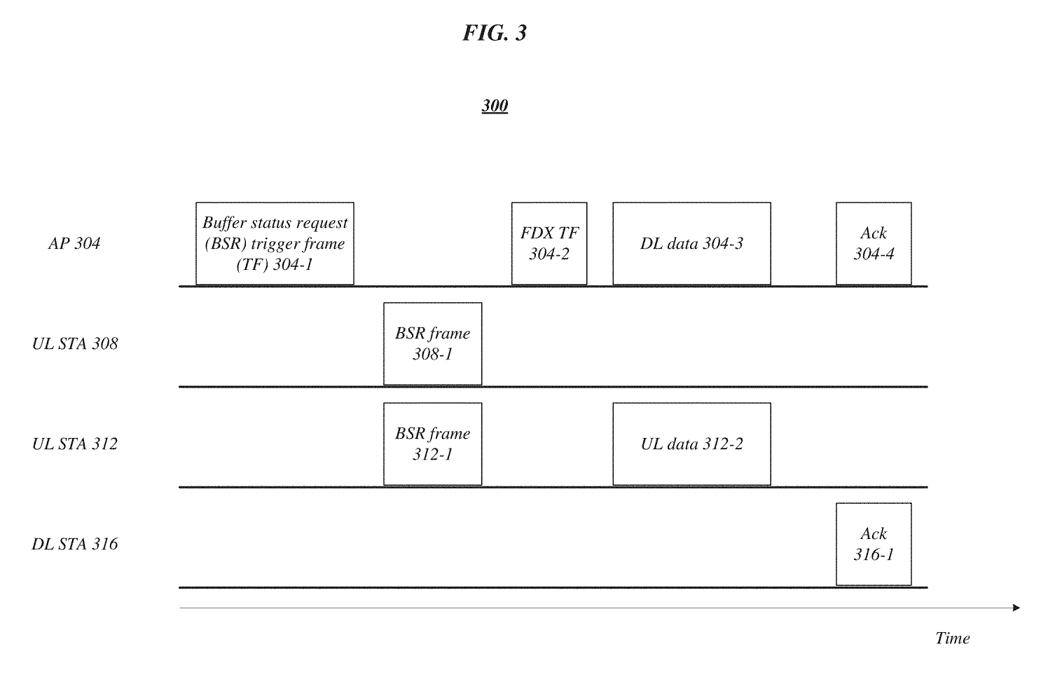

FIG. 3 illustrates an example of a communications flow 300 that may be representative of interactions between various nodes that may be performed in various embodiments to realize FDX communications on a wireless channel. In communications flow 300, the interactions may enable AP 304 to simultaneously transmit DL data 304-3 to DL STA 316 and receive UL data 312-2 from UL STA 312. For example, AP 304 may include logic to determine to send DL data 304-3 to DL STA 316 on a wireless channel, identify UL STA 312 as having UL data 312-2 in queue for transmission to AP 304, and schedule the AP 304, UL STA 312, and DL STA 316 to utilize the wireless channel for FDX communication. In the illustrated embodiment, AP 304 may transmit a buffer status request (BSR) trigger frame (TF) 304-1 and UL STAs 308 and 312 may respond with respective BSR frames 308-1 and 312-1. In some embodiments, based, at least in part, on the BSR frames 308-1 and 312-1, AP 304 may transmit FDX TF 304-2. In various embodiments, FDX TF 304-2 may enable STAs 308, 312, 316 to determine if and when to participate in FDX communication with AP 304. For example, FDX TF 304-2 may indicate when UL STA 312 is to transmit UL data 312-2. Embodiments are not limited in this context.

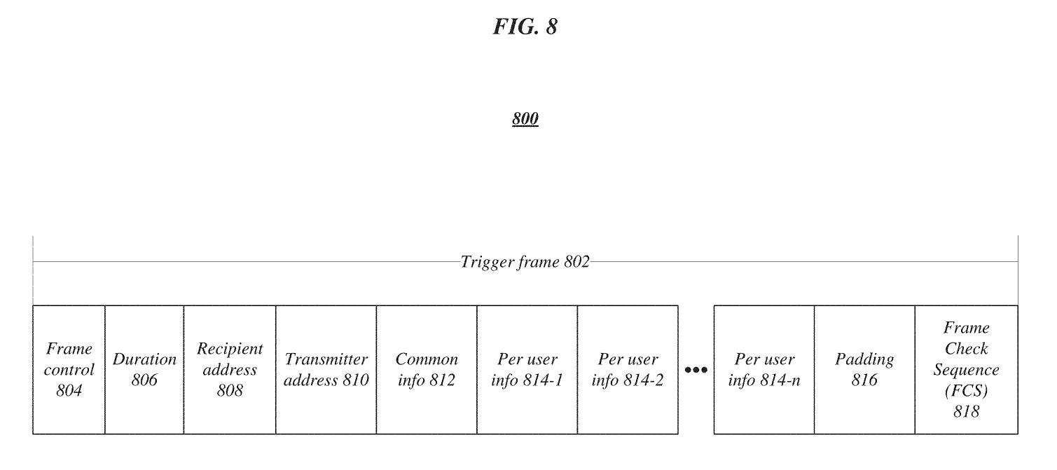

In some embodiments, communications flow 300 may employ a source-based transmission strategy, such as to perform one or more uplink sounding procedures. In some such embodiments, AP 304 may win contention of channel access for a DL transmission to DL STA 316, and, in order to decide which STA to pair with DL STA 316 for FDX transmissions, AP 304 may transmit BSR TF 304-1. In the illustrated embodiment, UL STA 308 and UL STA 312 may receive BSR TF 304-1. Upon receiving BSR TF 304-1, targeted STAs may feedback their buffer status in a BSR frame. Targeting of STAs is discussed in more detail below (see e.g., FIG. 8). In the illustrated embodiment, UL STA 308 responds with BSR frame 308-1 and UL STA 312 responds with BSR frame 312-1. AP 304 may then leverage the received buffer status of the candidate UL STAs (e.g., UL STAs 308 and 312), together with one or more other criterions, to decide which candidate UL STA to pair with DL STA 316 for HDX transmission. In the illustrated embodiment, AP 304 may identify UL STA 312 to pair with DL STA 316 and communicate this in FDX TF 304-2. Based on FDX TF 304-2, AP 304 may transmit DL data 304-3 in a time interval and UL STA 312 may transmit UL data 312-2 in the time interval. AP 304 may confirm or deny receipt of UL data 312-2 using Ack 304-4 and DL STA 316 may confirm or deny receipt of DL data 304-3 with Ack 316-1. In various embodiments, the procedure for sending/receiving one or more of BSR TF 304-1, BSR frame 308-1, and BSR frame 312-1 may be optional or previously performed. For instance, AP 308 may have already learned buffer status of UL STA 308 and UL STA 312 from a past transmission (e.g., queue size field of past STA data packet), thus removing the need for another buffer status report.

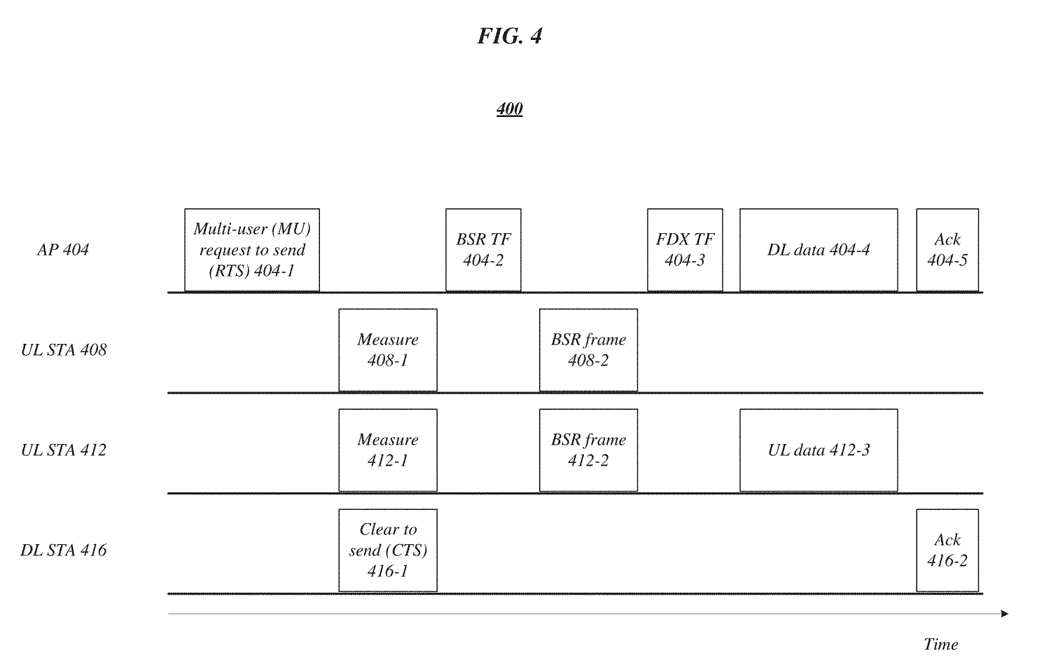

FIG. 4 illustrates an example of a communications flow 400 that may be representative of interactions between various nodes that may be performed in various embodiments to realize FDX communications on a wireless channel. In communications flow 400, the interactions may enable AP 404 to simultaneously transmit DL data 404-4 to DL STA 416 and receive UL data 412-3 from UL STA 412. For example, AP 404 may include logic to determine to simultaneously send DL data 404-4 to DL STA 416 on a wireless channel and receive UL data 412-3 on the wireless channel. In the illustrated embodiment, AP 404 may transmit a multi-user (MU) request to send (RTS) 404-1. In response to MU-RTS 404-1, UL STAs 408 and 412 may perform respective measures 408-1 and 412-2 as DL STA 416 transmits clear to send (CTS) 416-1. In various embodiments described herein, measure 408-1 may gauge STA-to-STA interference between UL STA 408 and DL STA 416 and measure 412-1 may gauge STA-to-STA interference between UL STA 412 and DL STA 416. In some embodiments, AP 404 may transmit buffer status request (BSR) trigger frame 404-2 and UL STAs 408 and 412 may respond with respective BSR frames 408-2 and 412-2. In various embodiments, BSR frame 408-2 may include an indication of measure 408-1 and BSR frame 412-2 may include an indication of measure 412-2. In some embodiments, based, at least in part, on BSR frames 408-2 and 412-2, AP 404 may transmit FDX TF 404-3. In various embodiments, FDX TF 404-3 may enable STAs 408, 412, 416 to determine if and when to participate in FDX communication with AP 404. For example, FDX TF 404-3 may indicate when UL STA 412 is to transmit UL data 412-3. Embodiments are not limited in this context.

In some embodiments, communications flow 400 may employ a source-based transmission strategy, such as to perform one or more uplink sounding procedures. AP 404 may utilize the buffer status report and interference measurements to trigger FD transmission. In some embodiments, one or more interference measurement procedures described herein may be referred to as sounding procedures. In some such embodiments, one or more sounding procedures may be conducted on top of existing IEEE 802.11ax sounding mechanisms for both source-based and destination-based FDX transmissions. In various embodiments, a MU-RTS/CTS mechanism may be utilized to measure interference. In the illustrated embodiment, UL STAs 408, 412 may measure the interference from CTS 416-1 from DL STA 416 they overhear and then include the interference information in their respective BSR frame. In some embodiments, AP 308 may utilize the BSR and the interference information to perform joint FDX scheduling. In various embodiments, one or more bits in the BSR frame may contain the quantized interference information feedback.

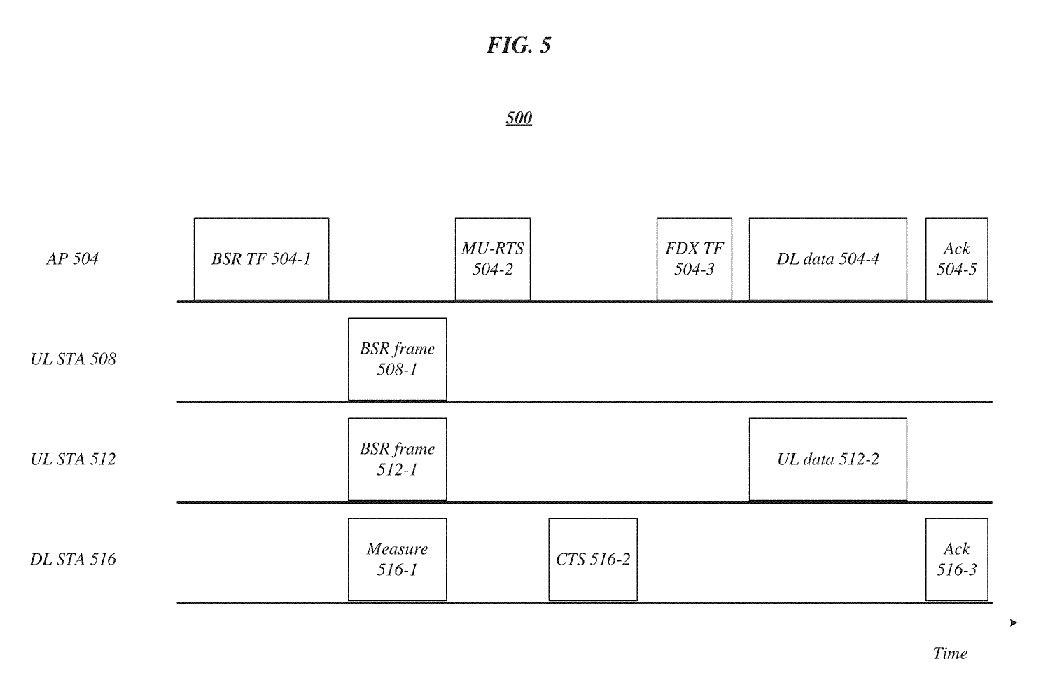

FIG. 5 illustrates an example of a communications flow 500 that may be representative of interactions between various nodes that may be performed in various embodiments to realize FDX communications on a wireless channel. In communications flow 500, the interactions may enable AP 504 to simultaneously transmit DL data 504-4 to DL STA 516 and receive UL data 512-2 from UL STA 512. For example, AP 504 may include logic to determine to simultaneously send DL data 504-4 to DL STA 516 on a wireless channel and receive UL data 512-2 on the wireless channel. In the illustrated embodiment, AP 504 may transmit BSR TF 504-1 and UL STAs 508 and 512 may respond with BSR frame 508-1 and 508-2, respectively. In various embodiments described herein, DL STA 516 may measure 516-1 interference caused by the transmission of BSR frame 508-1 and interference caused by the transmission of BSR frame 512-1. The interference may be fed back to AP 504, such as in CTS 516-2. In some embodiments, based, at least in part, on BSR frames 508-1 and 512-1 and measure 516-1, AP 504 may transmit FDX TF 504-3. In various embodiments, FDX TF 504-3 may enable STAs 508, 512, 516 to determine if and when to participate in FDX communication with AP 504. For example, FDX TF 504-3 may indicate when UL STA 512 is to transmit UL data 512-2. Embodiments are not limited in this context.

In some embodiments, communications flow 500 may employ a source-based transmission strategy, such as to perform one or more uplink sounding procedures. In the illustrated embodiment, DL STA 516 may conduct interference measurement from one or more candidate UL STA's BSR frame and then DL STA 516 may utilize the measured interference to feedback to AP 504 a recommended setting. In various embodiments, the interference (e.g., measure 516-1) may be fed back to AP 504 in the form of a recommended modulation and coding scheme (MCS), a MCS degradation, or the like. For instance, CTS 516-2 may include additional information regarding MCS degradation for pairing with UL STAs sending BSR. In one example, CTS 516-2 may include an MCS recommendation for different frequency band by incorporating the impact of the interference it measures via UL BSR feedback signal (e.g., BSR frame 508-1 and/or 512-1).

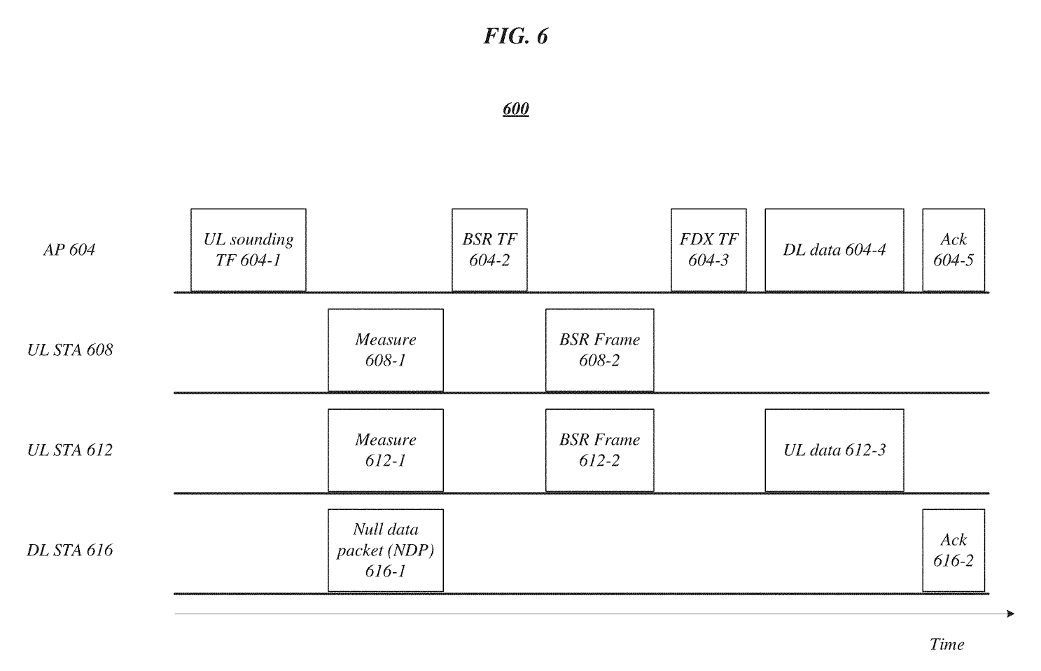

FIG. 6 illustrates an example of a communications flow 600 that may be representative of interactions between various nodes that may be performed in various embodiments to realize FDX communications on a wireless channel. In communications flow 600, the interactions may enable AP 604 to simultaneously transmit DL data 604-4 to DL STA 616 and receive UL data 612-3 from UL STA 612. For example, AP 604 may include logic to determine to simultaneously send DL data 604-4 to DL STA 616 on a wireless channel and receive UL data 612-3 on the wireless channel. In the illustrated embodiment, AP 604 may transmit UL sounding TF 604-1 and DL STA may respond with null data packet (NDP) 616-1. In response to UL sound TF 604-1, UL STAs 608 and 612 may perform respective measures 608-1 and 612-1 as DL STA 616 transmits null data packet (NDP) 616-1. In various embodiments described herein, measure 608-1 may gauge STA-to-STA interference between UL STA 608 and DL STA 616 and measure 612-1 may gauge STA-to-STA interference between UL STA 612 and DL STA 616. In some embodiments, AP 604 may transmit buffer status request (BSR) trigger frame 604-2 and UL STAs 608 and 612 may respond with respective BSR frames 608-2 and 612-2. In various embodiments, BSR frame 608-2 may include an indication of measure 608-1 and BSR frame 612-2 may include an indication of measure 612-1. In some embodiments, based, at least in part, on BSR frames 608-2 and 612-2, AP 604 may transmit FDX TF 604-3. In various embodiments, FDX TF 604-3 may enable STAs 608, 612, 616 to determine if and when to participate in FDX communication with AP 404. For example, FDX TF 604-3 may indicate when UL STA 612 is to transmit UL data 612-3. Embodiments are not limited in this context.

In some embodiments, communications flow 600 may employ a source-based transmission strategy, such as to perform one or more uplink sounding procedures. In various embodiments, AP 604 may utilize a trigger frame specific for uplink sounding to request some STA(s) and/or AP(s) send uplink sounding and request other STA(s) and/or AP(s) to measure it. In various embodiments, AP 604 may utilize a trigger frame specific for downlink sounding to request some STA(s) and/or AP(s) send downlink sounding and request other STA(s) and/or AP(s) to measure it. In various embodiments, communications flow 600 may include an uplink sounding procedure. For instance, AP 604 may send UL sounding TF 604-1 comprising UL sounding configurations for the target UL and DL STAs. DL STA 616 may transmit NDP 616-1 at a predefined time indicated in UL sounding TF 604-1 and UL STA 608 and UL STA 612 may measure the received signal strength of NDP 616-1. UL STA 608 may then send an indication of measure 608-1 in BSR frame 608-2 and UL STA 612 may send an indication of measure 612-1 in BSR frame 612-2. In some embodiments, BSR frames may include one or more bits (depending on granularity) to indicate the measured interference level. After AP 604 obtains the BSR information and interference information, it may schedule and send its FDX schedule decision in FDX TF 604-3.

In various embodiments, one or more changes/variations may be made to communications flow 600. For example, instead of arranging the DL STA to send out the NDP and the UL STA(s) to measure it, one may arrange a UL STA to send the NDP and a DL STA to measure it. In some embodiments, only DL STAs that are to be scheduled need to send sounding signals and only those UL STA(s) that have data in their buffer may send the feedback frame (e.g., BSR frame). In some embodiments, STAs may have multiple antennas. In some such embodiments, the DL STA may send one NDP on each antenna or transmit one NDP towards the received beam direction (if it is known), such that the UL STAs can measure the corresponding interference based on antenna pattern.

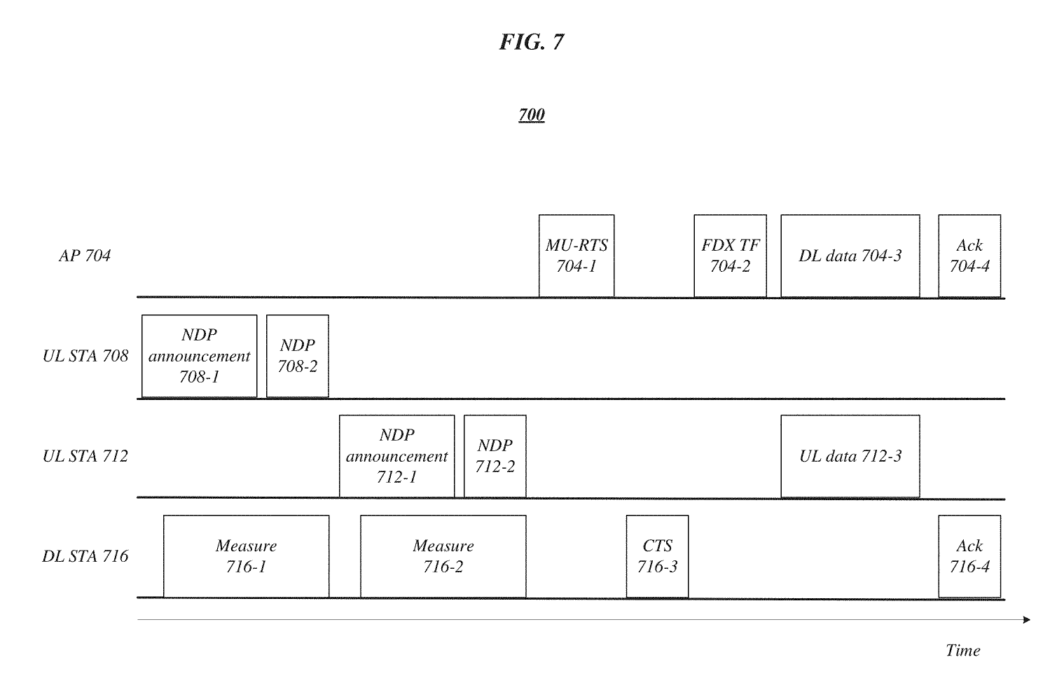

FIG. 7 illustrates an example of a communications flow 700 that may be representative of interactions between various nodes that may be performed in various embodiments to realize FDX communications on a wireless channel. In communications flow 700, the interactions may enable AP 704 to simultaneously transmit DL data 704-3 to DL STA 716 and receive UL data 712-3 from UL STA 712. For example, AP 704 may include logic to determine to simultaneously send DL data 704-3 to DL STA 716 on a wireless channel and receive UL data 712-3 on the wireless channel. In the illustrated embodiment, UL STA 708 may transmit NDP announcement 708-1 followed by NDP 708-2. In response to NDP announcement 708-1, DL STA 716 may measure 716-1 interference produced by NDP 708-2. UL STA 712 may transmit NDP announcement 712-1 followed by NDP 712-2. In response to NDP announcement 712-1, DL STA 716 may measure 716-2 interference produced by NDP 712-2. The interference may be fed back to AP 704, such as in CTS 716-3. In some embodiments, based, at least in part, CTS 716-3, AP 704 may transmit FDX TF 704-2. In various embodiments, FDX TF 704-2 may enable STAs 708, 712, 716 to determine if and when to participate in FDX communication with AP 704. For example, FDX TF 704-2 may indicate when UL STA 712 is to transmit UL data 712-3. Embodiments are not limited in this context.

In some embodiments, communications flow 700 may employ a destination-based transmission strategy, such as to perform one or more downlink sounding procedures. In various embodiments, STAs that have a transmission opportunity (TXOP) may send a NDP announcement and a NDP sequentially through contentions. When DL STA(s) hear the NDP announcement, they may start to measure the NDP packets at a predefined time. In some embodiments, the AP may also measure the NDP to be used for UL scheduling (e.g., MCS choice, power setting, etc.). In various embodiments, AP may send MU-RTS to candidate DL STAs for inquiry. In various such embodiments, one or more DL STAs may reply with a CTS with one or more additional bits used for interference feedback. In some embodiments, AP may then trigger FD transmission using FDX TF. In various embodiments, separate feedback frames may be used instead of the one or more additional bits in the CTS used for interference feedback.

FIG. 8 illustrates an example of a communications flow 800 that may be representative of interactions between various nodes that may be performed in various embodiments to realize FDX communications on a wireless channel. In communications flow 800, trigger frame 802 may be used in one or more interactions between nodes in a wireless network, such as AP 204 and STAs 250-1, 250-2, 250-n in wireless network 280. In various embodiments described herein, one or more versions of trigger frame 802 may be used to request information from one or more STAs or schedule one of the FDX transmissions. In the illustrated embodiment, trigger frame 802 may include frame control 804, duration 806, recipient address 808, transmitter address 810, common info 812, per user info 814-1, 814-2, 814-n, padding 816, and frame check sequence (FCS) 818. In some embodiments, common info 812 may include information on the type of trigger and per user info 814-1, 814-2, 814-n may include STA specific instructions. Embodiments are not limited in this context.

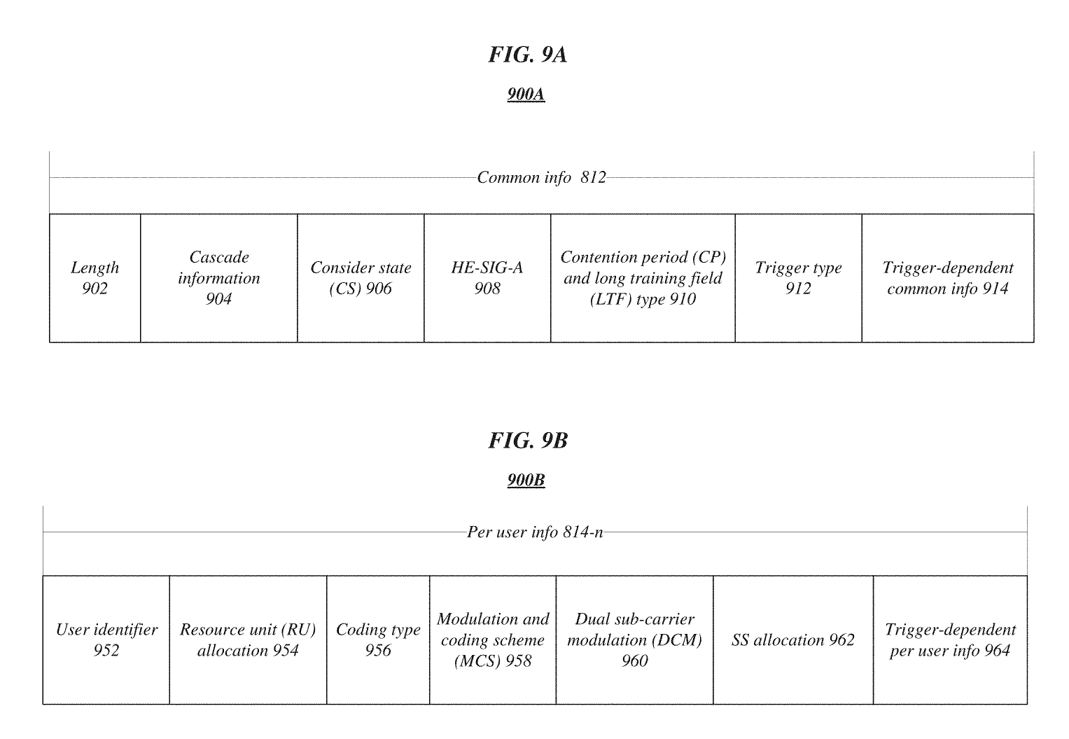

As previously mentioned, trigger frame 802 may include frame control 804, duration 806, recipient address 808, transmitter address 810, common info 812, per user info 814-1, 814-2, 814-n, padding 816 and FCS 818. The frame control 804 field may specify the form and function of the frame. The duration 806 field may indicate an amount of time, time remaining, or a time interval. In some embodiments, the recipient address 808 may identify the address of a recipient STA. The transmitter address 810 may include the address of the node transmitting the frame. The common info field 812 may include information on the type of trigger and will be described in more detail below (see e.g., FIG. 9A). The per user info 814-1, 814-2, 814-n may include STA specific instructions and will be described in more detail below (see e.g., FIG. 9B). Padding 816 may extend the frame length to give recipient STAs more time to prepare a response. FCS 818 field may enable an integrity check of received frames. It will be appreciated that while specific portions of trigger frame 802 may be used or described in various embodiments for interactions between nodes, any means to interact between nodes to enable FDX communication may be used without departing from the scope of this disclosure.

FIG. 9A illustrates an example of a communications flow 900A that may be representative of interactions between various nodes that may be performed in various embodiments to realize FDX communications on a wireless channel. In communications flow 900A, common info 812 may be used to identify a type of trigger frame (e.g., trigger frame 802). In various embodiments, common info 812 may identify trigger frame 802 as either a basic trigger, a beamforming report poll trigger, a MU-BAR, MU-RTS, FDX trigger, or UL sounding trigger. In some embodiments, the UL sounding trigger type may trigger uplink sounding for STA-to-STA measurement or uplink beamforming measurement. In various embodiments, the beamforming report poll trigger type may cause an AP to send a sounding signal and ask a DL STA to report sounding feedback. In some embodiments, FDX trigger type may trigger a DL STA and a UL STA to engage in a joint UL-DL transmission. In the illustrated embodiment, common info 812 may include length 902, cascade information 904, consider state (CS) 906, HE-SIG-A 908, contention period (CP) and long training field (LTF) type, trigger type 912, and trigger-dependent common info 914. In various embodiments described herein, trigger type 912 may indicate whether the trigger frame 802 that includes common info 812 is a basic trigger, a beamforming report poll trigger, a MU-BAR, MU-RTS, FDX trigger, or a UL sounding trigger. For instance, a binary ‘0’ may indicate a basic trigger, a binary ‘1’ may indicate a beamforming report poll trigger, a binary ‘2’ may indicate a MU-BAR, a binary ‘3’ may indicate a MU-RTS, a binary ‘4’ may indicate a FDX trigger, and a binary ‘5’ may indicate a UL sounding trigger. Embodiments are not limited in this context.

FIG. 9B illustrates an example of a communications flow 900B that may be representative of interactions between various nodes that may be performed in various embodiments to realize FDX communications on a wireless channel. In communications flow 900B, per user info 814-n may be used to indicate to specific STAs whether they shall send or measure uplink sounding signals in a trigger frame 802. In various embodiments, the same or similar per user info 814-n of FIG. 9B may represent each of per user info 814-1, 814-2, 814-n of FIG. 8. In the illustrated embodiment, per user info 814-n may include user identifier 952, resource unit (RU) allocation 954, coding type 956, MCS 958, dual sub-carrier modulation (DCM) 960, SS allocation 962, and trigger-dependent per user info 964. In some embodiments, user identifier 952 may indicate which STA a particular per user info 814-n is targeted at (e.g., STA 250-1, 250-2, 250-n) and trigger-dependent per user info 964 may indicate to the addressed STA whether it shall send or measure uplink sounding signals. For instance, trigger-dependent per user info 964 may include two bits to provide indications as follows: binary ‘0’ may indicate that the addressed STA is not used, binary ‘1’ may indicate that the addressed STA shall send an uplink sounding signal for FDX, binary ‘2’ may indicate that the addressed STA shall feedback the measured uplink sounding signal, and binary ‘3’ may indicate that the addressed STA shall send an uplink sounding signal for beamforming. In various embodiments, per user info 814-n may be able to differentiate sounding signals used for beamforming from sounding signals used for FDX. For instance, when a STA receives binary ‘1’, it may send out FD sounding signals. However, for UL beamforming, it's the AP that needs to measure the UL sounding signal, thus there is no need to include UL STA in a per user info. Embodiments are not limited in this context.

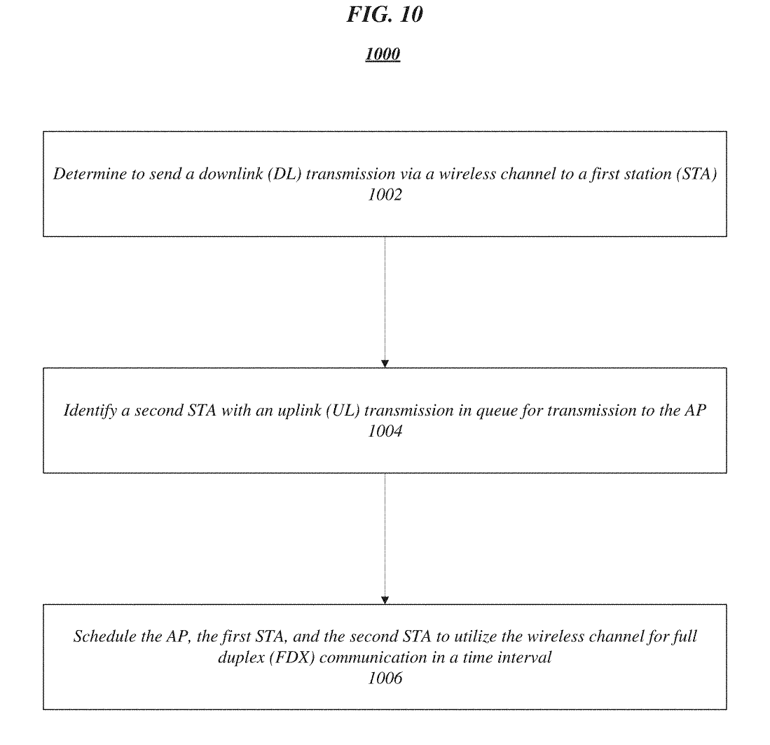

FIG. 10 illustrates one embodiment of a logic flow 1000, which may be representative of operations that may be executed in various embodiments in conjunction with the techniques for FDX communication described herein. The logic flow 1000 may be representative of some or all the operations that may be executed by one or more of FDX capable device 104 of FIG. 1 and APs 204, 304, 404, 504, 604, 704 of FIGS. 2-7. Embodiments are not limited in this context.

In the illustrated embodiment shown in FIG. 10, the logic flow 1000 may begin at block 1002. At block 1002 “determine to send a downlink (DL) transmission via a wireless channel to a first station (STA)” a DL transmission may be determined to send to a first STA via a wireless channel. For example, FDX capable device 104 may identify a DL transmission 124 to send to HDX capable device 116. Continuing to block 1002 “identify a second STA with a UL transmission in queue for transmission to the AP” a second STA with a UL transmission in queue for transmission to the AP may be identified. For example, FDX capable device 104 may identify that HDX capable device 102 has a UL transmission in queue for transmission to FDX capable device 104. In some embodiments, this may be based on a buffer status report.

In block 1006 “schedule the AP, the first STA and the second STA to utilize the wireless channel for FDX communication in a time interval” the AP and the first and second STAs may be scheduled to utilize the wireless channel for FDX communication. For example, FDX capable device 104 may transmit a FDX trigger frame (e.g., FDX TF 304-2, 404-3, 504-3, 604-3, 704-2). In some embodiments, the FDX trigger frame may indicate a time or time interval for AP 204, STA 250-1, and STA 250-2 to engage in FDX communications.

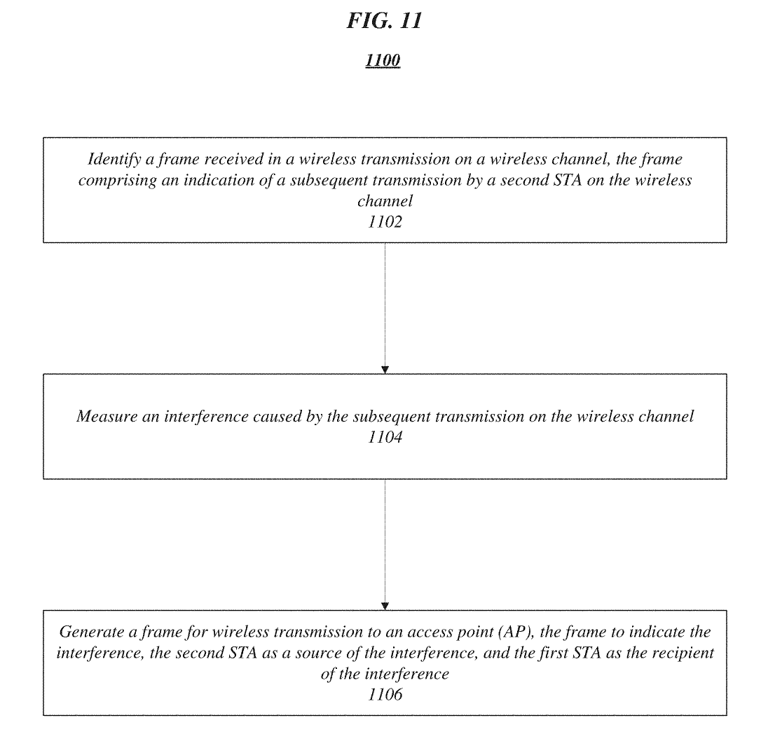

FIG. 11 illustrates one embodiment of a logic flow 1100, which may be representative of operations that may be executed in various embodiments in conjunction with the techniques for FDX communication described herein. The logic flow 1100 may be representative of some or all of the operations that may be executed by one or more of HDX capable devices 112 or 116 and one or more STAs of FIGS. 2-7. Embodiments are not limited in this context.

In the illustrated embodiment shown in FIG. 11, the logic flow 1100 may begin at block 1102. At block 1102 “identify a frame received in a wireless transmission on a wireless channel, the frame comprising an indication of a subsequent transmission by a second STA on the wireless channel” a frame comprising an indication of a subsequent transmission by a second STA on a wireless channel may be identified in a frame received in a wireless transmission. For example, AP 404 may transmit MU RTS 404-1. In some embodiments, the first STA may transmit the frame comprising an indication of a subsequent transmission by the second STA. Continuing to block 1102 “measure an interference caused by the subsequent transmission on the wireless channel” interference caused by the subsequent transmission on the wireless channel may be measured. For example, UL STA 408 and/or UL STA 412 may measure the interference caused by CTS 416-1 transmitted by DL STA 416. In some embodiments, DL STA 416 may measure interference of a frame transmitted by UL STA 408 or UL STA 412.

In block 1106 “generate a frame for wireless transmission to an AP, the frame to indicate the interference, the second STA as a source of the interference, and the first STA as the recipient of the interference” a frame may be generated for wireless transmission to an AP that indicates a measured interference and the identity of the source and recipient of the interference. For example, UL STA 412 may transmit BSR frame 412-2 that includes an indication of measure 412-1, DL STA 416 as the source of the interference, and UL STA 412 as the recipient of the interference. In some embodiments, the frame that indicates the measured interference and the source and recipient of the interference may include CTS 516-2.

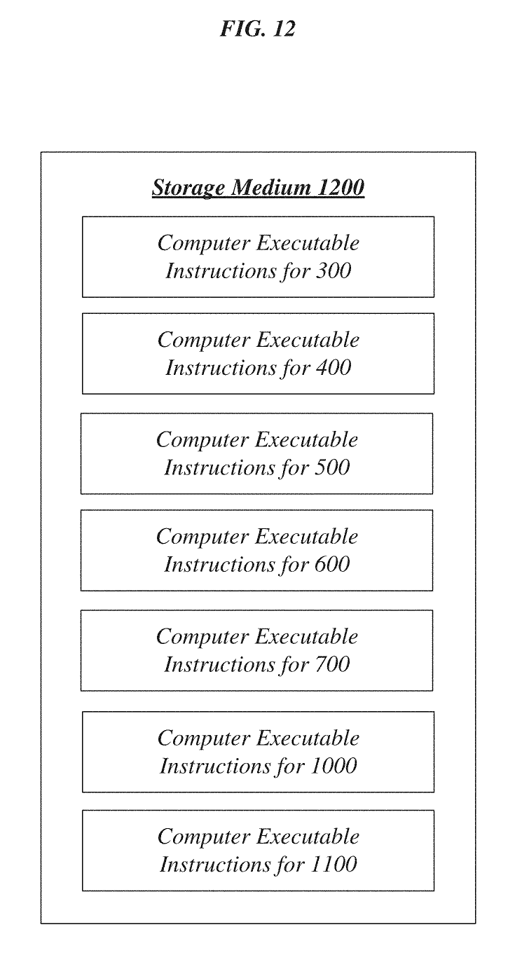

FIG. 12 illustrates an embodiment of a storage medium 1200. Storage medium 1200 may comprise any non-transitory computer-readable storage medium or machine-readable storage medium, such as an optical, magnetic or semiconductor storage medium. In various embodiments, storage medium 1200 may comprise an article of manufacture. In some embodiments, storage medium 1200 may store computer-executable instructions, such as computer-executable instructions to implement one or more of logic flow 1000 of FIG. 10 or logic flow 1100 of FIG. 11. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

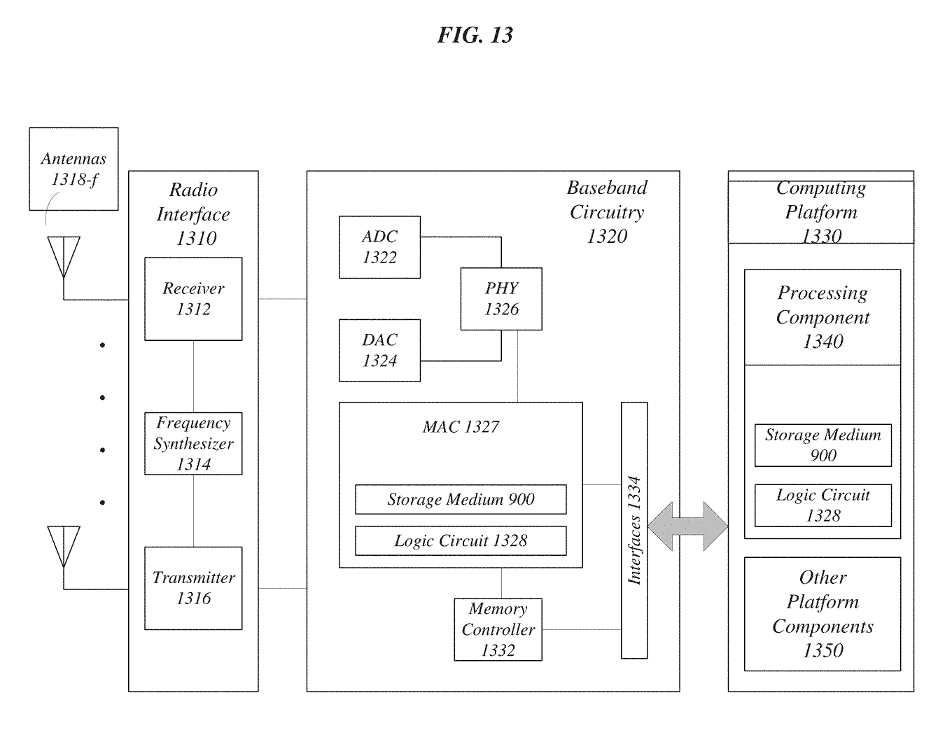

FIG. 13 illustrates an embodiment of a communications device 1300 that may implement one or more of FDX capable device 104, HDX capable device 112, or HDX capable device 116 of FIG. 1, AP 204, STA 250-1, STA 250-2, or STA 250-n of FIG. 2, or one or more APs, UL STAs, or DL STAs of FIGS. 3-7, logic flow 1000 of FIG. 10, logic flow 1100 of FIG. 11, and storage medium 1200 of FIG. 12. In various embodiments, device 1300 may comprise a logic circuit 1328. The logic circuit 1328 may include physical circuits to perform operations described for one or more of FDX capable device 104, HDX capable device 112, or HDX capable device 116 of FIG. 1, AP 204, STA 250-1, STA 250-2, or STA 250-n of FIG. 2, or one or more APs, UL STAs, or DL STAs of FIGS. 3-7, logic flow 1000 of FIG. 10, and logic flow 1100 of FIG. 11, for example. As shown in FIG. 13, device 1300 may include a radio interface 1310, baseband circuitry 1320, and computing platform 1330, although the embodiments are not limited to this configuration.

The device 1300 may implement some or all of the structure and/or operations for one or more of FDX capable device 104, HDX capable device 112, or HDX capable device 116 of FIG. 1, AP 204, STA 250-1, STA 250-2, or STA 250-n of FIG. 2, or one or more APs, UL STAs, or DL STAs of FIGS. 3-7, logic flow 1000 of FIG. 10, and logic circuit 1328 in a single computing entity, such as entirely within a single device. Alternatively, the device 1300 may distribute portions of the structure and/or operations for one or more of FDX capable device 104, HDX capable device 112, or HDX capable device 116 of FIG. 1, AP 204, STA 250-1, STA 250-2, or STA 250-n of FIG. 2, or one or more APs, UL STAs, or DL STAs of FIGS. 3-7, logic flow 1000 of FIG. 10, and logic circuit 1328 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1310 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1310 may include, for example, a receiver 1312, a frequency synthesizer 1314, and/or a transmitter 1316. Radio interface 1310 may include bias controls, a crystal oscillator and/or one or more antennas 1318-f. In another embodiment, radio interface 1310 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1320 may communicate with radio interface 1310 to process receive and/or transmit signals and may include, for example, an analog-to-digital converter 1322 for down converting received signals, a digital-to-analog converter 1324 for up converting signals for transmission. Further, baseband circuitry 1320 may include a baseband or physical layer (PHY) processing circuit 1326 for PHY link layer processing of respective receive/transmit signals. Baseband circuitry 1320 may include, for example, a medium access control (MAC) processing circuit 1327 for MAC/data link layer processing. Baseband circuitry 1320 may include a memory controller 1332 for communicating with MAC processing circuit 1327 and/or a computing platform 1330, for example, via one or more interfaces 1334.

In some embodiments, PHY processing circuit 1326 may include a frame construction and/or detection module, in combination with additional circuitry such as a buffer memory, to construct and/or deconstruct communication frames. Alternatively, or in addition, MAC processing circuit 1327 may share processing for certain of these functions or perform these processes independent of PHY processing circuit 1326. In some embodiments, MAC and PHY processing may be integrated into a single circuit.

The computing platform 1330 may provide computing functionality for the device 1300. As shown, the computing platform 1330 may include a processing component 1340. In addition to, or alternatively of, the baseband circuitry 1320, the device 1300 may execute processing operations or logic for one or more of FDX capable device 104, HDX capable device 112, or HDX capable device 116 of FIG. 1, AP 204, STA 250-1, STA 250-2, or STA 250-n of FIG. 2, or one or more APs, UL STAs, or DL STAs of FIGS. 3-7, logic flow 1000 of FIG. 10, and logic circuit 1328 using the processing component 1340. The processing component 1340 (and/or PHY 1326 and/or MAC 1327) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1330 may further include other platform components 1350. Other platform components 1350 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1300 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1300 described herein, may be included or omitted in various embodiments of device 1300, as suitably desired.

Embodiments of device 1300 may be implemented using single input single output (SISO) architectures. However, certain implementations may include multiple antennas (e.g., antennas 1318-f) for transmission and/or reception using adaptive antenna techniques for beamforming or spatial division multiple access (SDMA) and/or using MIMO communication techniques.

The components and features of device 1300 may be implemented using any combination of discrete circuitry, application specific integrated circuits (ASICs), logic gates and/or single chip architectures. Further, the features of device 1300 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1300 shown in the block diagram of FIG. 13 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

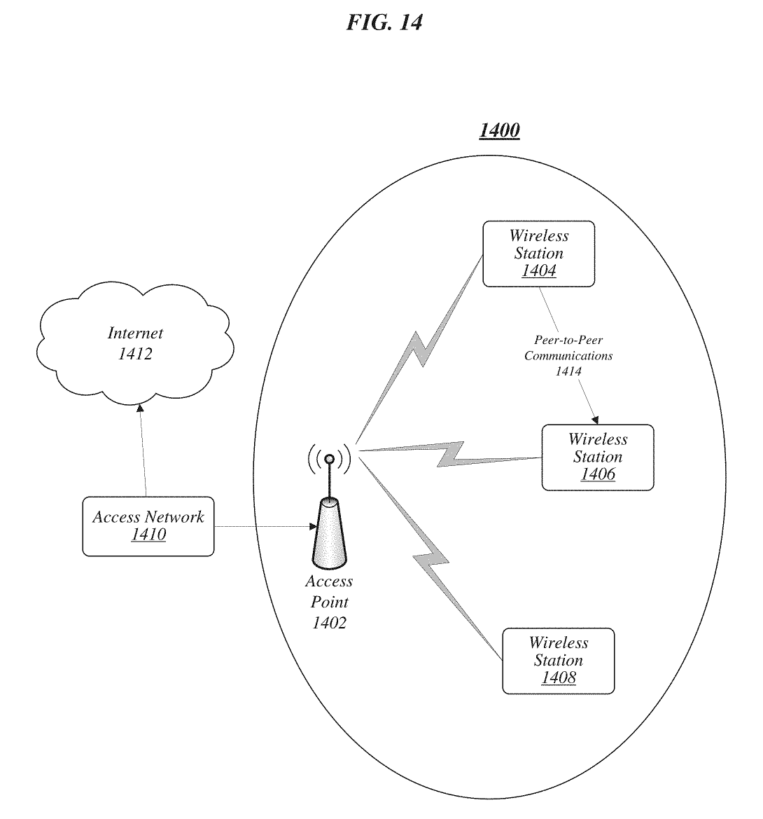

FIG. 14 illustrates an embodiment of a wireless network 1400. As shown in FIG. 14, wireless network comprises an access point 1402 and wireless stations 1404, 1406, and 1408. In various embodiments, wireless network 1400 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 1400 may comprise another type of wireless network, and/or may implement other wireless communications standards. In various embodiments, for example, wireless network 1400 may comprise a WWAN or WPAN rather than a WLAN. The embodiments are not limited to this example.

In some embodiments, wireless network 1400 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 1404, 1406, and 1408 may communicate with access point 1402 in order to obtain connectivity to one or more external data networks. In some embodiments, for example, wireless stations 1404, 1406, and 1408 may connect to the Internet 1412 via access point 1402 and access network 1410. In various embodiments, access network 1410 may comprise a private network that provides subscription-based Internet-connectivity, such as an Internet Service Provider (ISP) network. The embodiments are not limited to this example.

In various embodiments, two or more of wireless stations 1404, 1406, and 1408 may communicate with each other directly by exchanging peer-to-peer communications. For example, in the example of FIG. 14, wireless stations 1404 and 1406 communicate with each other directly by exchanging peer-to-peer communications 1414. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which number permutations and configurations will be apparent.

Example 1 is an apparatus to manage a wireless network, comprising: a memory; and logic for an access point (AP), at least a portion of the logic implemented in circuitry coupled to the memory, the logic to: determine to send a downlink (DL) transmission via a wireless channel to a first station (STA); identify a second STA with an uplink (UL) transmission in queue for transmission to the AP; and schedule the AP, the first STA, and the second STA to utilize the wireless channel for full duplex (FDX) communication in a time interval.

Example 2 includes the subject matter of Example 1, the FDX communication to include simultaneous transmission of at least a portion of the DL transmission and receipt of at least a portion of the UL transmission via the wireless channel by the AP.

Example 3 includes the subject matter of any of Examples 1 to 2, the logic to signal the second STA to send the UL transmission in the time interval based on the schedule.

Example 4 includes the subject matter of any of Examples 1 to 3, the logic to determine to send the DL transmission via the wireless channel in the time interval to the first STA based on a contention process.

Example 5 includes the subject matter of any of Examples 1 to 4, the logic to: receive buffer status information from one or more candidate STAs, the one or more candidate STAs to include the second STA; and identify the UL transmission in queue for transmission to the AP based on the buffer status information associated with the second STA.

Example 6 includes the subject matter of any of Examples 1 to 5, the logic to request buffer status information from the one or more candidate STAs.

Example 7 includes the subject matter of any of Examples 1 to 6, the logic to identify a third STA with another UL transmission in queue for transmission to the AP.

Example 8 includes the subject matter of Example 7, the logic to select the second STA to pair with the first STA based on one or more characteristics of one or more of the UL transmission, the other UL transmission, or the DL transmission.

Example 9 includes the subject matter of Example 7, the logic to select the second STA to pair with the first STA based on comparison of a second interference measurement associated with the second STA and a third interference measurement associated with the third STA.

Example 10 includes the subject matter of Example 9, the logic to generate a pair-able table based on the second and third interference measurements.

Example 11 includes the subject matter of Example 9, the second and third interference measurements performed by the first STA.

Example 12 includes the subject matter of Example 9, the second interference measurement performed by the second STA and the third interference measurement performed by the third STA.

Example 13 includes the subject matter of Example 9, the logic to generate a trigger frame for wireless transmission, the trigger frame to instigate the second and third interference measurements.

Example 14 includes the subject matter of Example 13, the logic to generate another trigger frame for wireless transmission, the other trigger frame to request a report for each of the second and third interference measurements.

Example 15 includes the subject matter of Example 13, the trigger frame to instigate a first wireless transmission by the first STA, the second and third interference measurements based on the wireless transmission by the first STA.

Example 16 includes the subject matter of Example 13, the trigger frame to instigate a second wireless transmission by the second STA and a third wireless transmission by the third STA, the second interference measurement based on the second wireless transmission and the third interference measurement based on the third wireless transmission.

Example 17 is a system, comprising: an apparatus according to any of Examples 1 to 15; and at least one radio frequency (RF) transceiver.

Example 18 includes the subject matter of Example 16, comprising one or more of a processor and an RF antenna.

Example 19 is an apparatus for wireless communication, comprising: a memory; and logic for a first station (STA), at least a portion of the logic implemented in circuitry coupled to the memory, the logic to: identify a frame received in a wireless transmission on a wireless channel, the frame comprising an indication of a subsequent transmission by a second STA on the wireless channel; measure an interference caused by the subsequent transmission on the wireless channel; and generate a frame for wireless transmission to an access point (AP), the frame to indicate the interference, the second STA as a source of the interference, and the first STA as the recipient of the interference.

Example 20 includes the subject matter of Example 19, the first STA to provide a destination for a downlink (DL) transmission from the AP in a full duplex (FDX) communication with the second STA and the AP via the wireless channel.

Example 21 includes the subject matter of any of Examples 19 to 20, the first STA to generate a frame for an uplink (UL) transmission to the AP in a full duplex (FDX) communication with the second STA and the AP via the wireless channel.

Example 22 includes the subject matter of any of Examples 19 to 21, the second STA to send the frame received in the wireless transmission.

Example 23 includes the subject matter of any of Examples 19 to 22, the AP to send the frame received in the wireless transmission.

Example 24 includes the subject matter of any of Examples 19 to 23, the frame received in the wireless transmission comprising a null data packet announcement (NDPA).

Example 25 includes the subject matter of any of Examples 19 to 24, the subsequent transmission comprising a null data packet (NDP).

Example 26 includes the subject matter of any of Examples 19 to 25, the frame received in the wireless transmission comprising a trigger frame with a buffer status report request (BSR).

Example 27 includes the subject matter of any of Examples 19 to 26, the frame generated for wireless transmission comprising a buffer status report (BSR) frame including an indication of a queue status of the first STA.

Example 28 includes the subject matter of any of Examples 19 to 23, the subsequent transmission comprising a clear to send (CTS) frame.

Example 29 includes the subject matter of any of Examples 19 to 23, the subsequent transmission comprising a BSR frame.

Example 30 includes the subject matter of any of Examples 19 to 29, the first STA, the second STA, and the AP to engage in full duplex (FDX) communication via the wireless channel.

Example 31 is a system, comprising: an apparatus according to any of Examples 19 to 30; and at least one radio frequency (RF) transceiver.

Example 32 includes the subject matter of Example 31, comprising at least one processor.

Example 33 includes the subject matter of any of Examples 31 to 32, comprising at least one RF antenna.

Example 34 is at least one non-transitory computer-readable medium comprising a set of instructions that, in response to being executed at a wireless communication device, cause the wireless communication device to: determine to send a downlink (DL) transmission via a wireless channel to a first station (STA); identify a second STA with an uplink (UL) transmission in queue for transmission to the AP; and schedule the AP, the first STA, and the second STA to utilize the wireless channel for full duplex (FDX) communication in a time interval.

Example 35 includes the subject matter of Example 34, the FDX communication to include simultaneous transmission of at least a portion of the DL transmission and receipt of at least a portion of the UL transmission via the wireless channel by the AP.

Example 36 includes the subject matter of any of Examples 34 to 35, comprising instructions that, in response to being executed at the wireless communication device, cause the wireless communication device to signal the second STA to send the UL transmission in the time interval based on the schedule.

Example 37 includes the subject matter of any of Examples 34 to 36, comprising instructions that, in response to being executed at the wireless communication device, cause the wireless communication device to determine to send the DL transmission via the wireless channel in the time interval to the first STA based on a contention process.

Example 38 includes the subject matter of any of Examples 34 to 37, comprising instructions that, in response to being executed at the wireless communication device, cause the wireless communication device to: receive buffer status information from the second STA; and identify the UL transmission in queue for transmission to the AP based on the buffer status information.

Example 39 includes the subject matter of any of Examples 34 to 38, comprising instructions that, in response to being executed at the wireless communication device, cause the wireless communication device to request buffer status information from the second STA.

Example 40 includes the subject matter of any of Examples 34 to 39, comprising instructions that, in response to being executed at the wireless communication device, cause the wireless communication device to identify a third STA with another UL transmission in queue for transmission to the AP.

Example 41 includes the subject matter of Example 40, comprising instructions that, in response to being executed at the wireless communication device, cause the wireless communication device to select the second STA to pair with the first STA based on one or more characteristics of one or more of the UL transmission, the other UL transmission, or the DL transmission.

Example 42 includes the subject matter of Example 40, comprising instructions that, in response to being executed at the wireless communication device, cause the wireless communication device to select the second STA to pair with the first STA based on comparison of a second interference measurement associated with the second STA and a third interference measurement associated with the third STA.

Example 43 includes the subject matter of Example 42, comprising instructions that, in response to being executed at the wireless communication device, cause the wireless communication device to generate a pair-able table based on the second and third interference measurements.

Example 44 includes the subject matter of Example 42, the second and third interference measurements performed by the first STA.

Example 45 includes the subject matter of Example 42, the second interference measurement performed by the second STA and the third interference measurement performed by the third STA.

Example 46 includes the subject matter of Example 42, comprising instructions that, in response to being executed at the wireless communication device, cause the wireless communication device to generate a trigger frame for wireless transmission, the trigger frame to instigate the second and third interference measurements.

Example 47 includes the subject matter of Example 46, the trigger frame to instigate a first wireless transmission by the first STA, the second and third interference measurements based on the wireless transmission by the first STA.

Example 48 includes the subject matter of Example 46, the trigger frame to instigate a second wireless transmission by the second STA and a third wireless transmission by the third STA, the second interference measurement based on the second wireless transmission and the third interference measurement based on the third wireless transmission.

Example 49 is at least one non-transitory computer-readable medium comprising a set of instructions that, in response to being executed at a wireless communication device, cause the wireless communication device to: identify a frame received at a first station (STA) in a wireless transmission on a wireless channel, the frame comprising an indication of a subsequent transmission by a second STA on the wireless channel; measure an interference caused by the subsequent transmission on the wireless channel; and generate a frame for wireless transmission to an access point (AP), the frame to indicate the interference, a source of the interference, and a recipient of the interference.

Example 50 includes the subject matter of Example 49, the first STA to provide a destination for a downlink (DL) transmission from the AP in a full duplex (FDX) communication with the second STA and the AP via the wireless channel.

Example 51 includes the subject matter of any of Examples 49 to 50, the first STA to generate a frame for an uplink (UL) transmission to the AP in a full duplex (FDX) communication with the second STA and the AP via the wireless channel.

Example 52 includes the subject matter of any of Examples 49 to 51, the second STA or the AP to send the frame received in the wireless transmission.

Example 53 includes the subject matter of any of Examples 49 to 52, the frame received in the wireless transmission comprising a null data packet announcement (NDPA), a buffer status report (BSR) trigger frame (TF), a sounding TF, or a multi-user request to send (MU-RTS).

Example 54 includes the subject matter of any of Examples 49 to 53, the subsequent transmission comprising a clear to send (CTS) frame, a buffer status report (BSR) frame, or a null data packet (NDP).

Example 55 includes the subject matter of any of Examples 49 to 54, the frame generated for wireless transmission comprising a buffer status report (BSR) frame including an indication of a queue status of the first STA.

Example 56 include the subject matter of any of Examples 49 to 55, the frame generated for wireless transmission to indicate the first STA as the source of the interference and the second STA as the recipient of the interference.

Example 57 include the subject matter of Example 56, the frame generated for wireless transmission comprising a buffer status report (BSR) frame.

Example 58 include the subject matter of any of Examples 49 to 56, the frame generated for wireless transmission to indicate the first STA as the recipient of the interference and the second STA as the source of the interference.

Example 59 include the subject matter of Example 58, the frame generated for wireless transmission comprising a clear to send (CTS) frame.

Example 60 includes the subject matter of any of Examples 49 to 59, the first STA, the second STA, and the AP to engage in full duplex (FDX) communication via the wireless channel.

Example 61 is a method to manage a wireless network, comprising: determining to send a downlink (DL) transmission via a wireless channel to a first station (STA); identifying a second STA with an uplink (UL) transmission in queue for transmission to the AP; and scheduling the AP, the first STA, and the second STA to utilize the wireless channel for full duplex (FDX) communication in a time interval.

Example 62 includes the subject matter of Example 61, the FDX communication including simultaneous transmission of at least a portion of the DL transmission and receipt of at least a portion of the UL transmission via the wireless channel by the AP.

Example 63 includes the subject matter of any of Examples 61 to 62, comprising signaling the second STA to send the UL transmission in the time interval based on the schedule.

Example 64 includes the subject matter of any of Examples 61 to 63, comprising determining to send the DL transmission via the wireless channel in the time interval to the first STA based on a contention process.

Example 65 includes the subject matter of any of Examples 61 to 64, comprising: receiving buffer status information from the second STA; and identifying the UL transmission in queue for transmission to the AP based on the buffer status information.

Example 66 includes the subject matter of any of Examples 61 to 65, comprising requesting buffer status information from the second STA.

Example 67 includes the subject matter of any of Examples 61 to 66, comprising identifying a third STA with another UL transmission in queue for transmission to the AP.

Example 68 includes the subject matter of Example 67, comprising selecting the second STA to pair with the first STA based on one or more characteristics of one or more of the UL transmission, the other UL transmission, or the DL transmission.

Example 69 includes the subject matter of Example 67, comprising selecting the second STA to pair with the first STA based on comparison of a second interference measurement associated with the second STA and a third interference measurement associated with the third STA.

Example 70 includes the subject matter of Example 69, comprising generating a pair-able table based on the second and third interference measurements.

Example 71 includes the subject matter of Example 69, the second and third interference measurements performed by the first STA.

Example 72 includes the subject matter of Example 69, the second interference measurement performed by the second STA and the third interference measurement performed by the third STA.

Example 73 includes the subject matter of Example 69, comprising generating a trigger frame for wireless transmission, the trigger frame to instigate the second and third interference measurements.

Example 74 includes the subject matter of Example 73, the trigger frame to instigate a first wireless transmission by the first STA, the second and third interference measurements based on the wireless transmission by the first STA.

Example 75 includes the subject matter of Example 73, the trigger frame to instigate a second wireless transmission by the second STA and a third wireless transmission by the third STA, the second interference measurement based on the second wireless transmission and the third interference measurement based on the third wireless transmission.

Example 76 is a method for wireless communication, comprising: identifying a frame received in a wireless transmission on a wireless channel, the frame comprising an indication of a subsequent transmission by a second STA on the wireless channel; measuring an interference caused by the subsequent transmission on the wireless channel; and generating a frame for wireless transmission to an access point (AP), the frame to indicate the interference, the second STA as a source of the interference, and the first STA as the recipient of the interference.

Example 77 includes the subject matter of Example 76, the first STA to provide a destination for a downlink (DL) transmission from the AP in a full duplex (FDX) communication with the second STA and the AP via the wireless channel.

Example 78 includes the subject matter of any of Examples 76 to 77, the first STA to generate a frame for an uplink (UL) transmission to the AP in a full duplex (FDX) communication with the second STA and the AP via the wireless channel.

Example 79 includes the subject matter of any of Examples 76 to 78, the second STA to send the frame received in the wireless transmission.

Example 80 includes the subject matter of any of Examples 76 to 79, the AP to send the frame received in the wireless transmission.

Example 81 includes the subject matter of any of Examples 76 to 80, the frame received in the wireless transmission comprising a null data packet announcement (NDPA).

Example 82 includes the subject matter of any of Examples 76 to 81, the subsequent transmission comprising a null data packet (NDP).

Example 83 includes the subject matter of any of Examples 76 to 82, the frame received in the wireless transmission comprising a trigger frame with a buffer status report request (BSR).

Example 84 includes the subject matter of any of Examples 76 to 83, the frame generated for wireless transmission comprising a buffer status report (BSR) frame including an indication of a queue status of the first STA.

Example 85 includes the subject matter of any of Examples 76 to 80, the subsequent transmission comprising a clear to send (CTS) frame.

Example 86 includes the subject matter of any of Examples 76 to 80, the subsequent transmission comprising a BSR frame.

Example 87 includes the subject matter of any of Examples 76 to 86, the first STA, the second STA, and the AP to engage in full duplex (FDX) communication via the wireless channel.

Example 88 is an apparatus to manage a wireless network, comprising: means for determining to send a downlink (DL) transmission via a wireless channel to a first station (STA); means for identifying a second STA with an uplink (UL) transmission in queue for transmission to the AP; and means for scheduling the AP, the first STA, and the second STA to utilize the wireless channel for full duplex (FDX) communication in a time interval.

Example 89 includes the subject matter of Example 88, the FDX communication including simultaneous transmission of at least a portion of the DL transmission and receipt of at least a portion of the UL transmission via the wireless channel by the AP.

Example 90 includes the subject matter of any of Examples 88 to 89, comprising means for signaling the second STA to send the UL transmission in the time interval based on the schedule.

Example 91 includes the subject matter of any of Examples 88 to 90, comprising means for determining to send the DL transmission via the wireless channel in the time interval to the first STA based on a contention process.

Example 92 includes the subject matter of any of Examples 88 to 91, comprising: means for receiving buffer status information from the second STA; and means for identifying the UL transmission in queue for transmission to the AP based on the buffer status information.

Example 93 includes the subject matter of any of Examples 88 to 92, comprising means for requesting buffer status information from the second STA.

Example 94 includes the subject matter of any of Examples 88 to 93, comprising means for identifying a third STA with another UL transmission in queue for transmission to the AP.

Example 95 includes the subject matter of Example 94, comprising means for selecting the second STA to pair with the first STA based on one or more characteristics of one or more of the UL transmission, the other UL transmission, or the DL transmission.

Example 96 includes the subject matter of Example 94, comprising means for selecting the second STA to pair with the first STA based on comparison of a second interference measurement associated with the second STA and a third interference measurement associated with the third STA.

Example 97 includes the subject matter of Example 96, comprising means for generating a pair-able table based on the second and third interference measurements.

Example 98 includes the subject matter of Example 96, the second and third interference measurements performed by the first STA.

Example 99 includes the subject matter of Example 96, the second interference measurement performed by the second STA and the third interference measurement performed by the third STA.

Example 100 includes the subject matter of Example 96, comprising means for generating a trigger frame for wireless transmission, the trigger frame to instigate the second and third interference measurements.

Example 101 includes the subject matter of Example 100, the trigger frame to instigate a first wireless transmission by the first STA, the second and third interference measurements based on the wireless transmission by the first STA.

Example 102 includes the subject matter of Example 100, the trigger frame to instigate a second wireless transmission by the second STA and a third wireless transmission by the third STA, the second interference measurement based on the second wireless transmission and the third interference measurement based on the third wireless transmission.

Example 103 is an apparatus for wireless communication, comprising: means for identifying a frame received in a wireless transmission on a wireless channel, the frame comprising an indication of a subsequent transmission by a second STA on the wireless channel; means for measuring an interference caused by the subsequent transmission on the wireless channel; and means for generating a frame for wireless transmission to an access point (AP), the frame to indicate the interference, the second STA as a source of the interference, and the first STA as the recipient of the interference.

Example 104 includes the subject matter of Example 103, the first STA to provide a destination for a downlink (DL) transmission from the AP in a full duplex (FDX) communication with the second STA and the AP via the wireless channel.

Example 105 includes the subject matter of any of Examples 103 to 104, the first STA to generate a frame for an uplink (UL) transmission to the AP in a full duplex (FDX) communication with the second STA and the AP via the wireless channel.

Example 106 includes the subject matter of any of Examples 103 to 105, the second STA to send the frame received in the wireless transmission.

Example 107 includes the subject matter of any of Examples 103 to 106, the AP to send the frame received in the wireless transmission.

Example 108 includes the subject matter of any of Examples 103 to 107, the frame received in the wireless transmission comprising a null data packet announcement (NDPA).

Example 109 includes the subject matter of any of Examples 103 to 108, the subsequent transmission comprising a null data packet (NDP).

Example 110 includes the subject matter of any of Examples 103 to 109, the frame received in the wireless transmission comprising a trigger frame with a buffer status report request (BSR).

Example 111 includes the subject matter of any of Examples 103 to 110, the frame generated for wireless transmission comprising a buffer status report (BSR) frame including an indication of a queue status of the first STA.

Example 112 includes the subject matter of any of Examples 103 to 107, the subsequent transmission comprising a clear to send (CTS) frame.

Example 113 includes the subject matter of any of Examples 103 to 107, the subsequent transmission comprising a BSR frame.

Example 114 includes the subject matter of any of Examples 103 to 113, the first STA, the second STA, and the AP to engage in full duplex (FDX) communication via the wireless channel.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus to manage a wireless network, comprising:
a memory; and
logic for an access point (AP), at least a portion of the logic implemented in circuitry coupled to the memory, the logic to:
determine to send a downlink (DL) transmission via a wireless channel to a first station (STA);
identify a second STA with an uplink (UL) transmission in queue for transmission to the AP; and
schedule the AP, the first STA, and the second STA to utilize the wireless channel for full duplex (FDX) communication in a time interval.

2. The apparatus of claim 1, the FDX communication to include simultaneous transmission of at least a portion of the DL transmission and receipt of at least a portion of the UL transmission via the wireless channel by the AP.

3. The apparatus of claim 1, the logic to signal the second STA to send the UL transmission in the time interval based on the schedule.

4. The apparatus of claim 1, the logic to determine to send the DL transmission via the wireless channel in the time interval to the first STA based on a contention process.

5. The apparatus of claim 1, the logic to:
receive buffer status information from one or more candidate STAs, the one or more candidate STAs to include the second STA; and
identify the UL transmission in queue for transmission to the AP based on the buffer status information associated with the second STA.

6. The apparatus of claim 5, the logic to request the buffer status information from the one or more candidate STAs.

7. The apparatus of claim 1, the logic to identify a third STA with another UL transmission in queue for transmission to the AP.

8. The apparatus of claim 7, the logic to select the second STA to pair with the first STA based on one or more characteristics of one or more of the UL transmission, the other UL transmission, or the DL transmission.

9. The apparatus of claim 7, the logic to select the second STA to pair with the first STA based on comparison of a second interference measurement associated with the second STA and a third interference measurement associated with the third STA.

10. The apparatus of claim 9, the logic to generate a pair-able table based on the second and third interference measurements.

11. The apparatus of claim 9, the second and third interference measurements performed by the first STA.

12. The apparatus of claim 9, the second interference measurement performed by the second STA and the third interference measurement performed by the third STA.

13. The apparatus of claim 9, the logic to generate a trigger frame for wireless transmission, the trigger frame to instigate the second and third interference measurements.

14. The apparatus of claim 13, the logic to generate another trigger frame for wireless transmission, the other trigger frame to request a report for each of the second and third interference measurements.

15. The apparatus of claim 13, the trigger frame to instigate a first wireless transmission by the first STA, the second and third interference measurements based on the first wireless transmission by the first STA.

16. The apparatus of claim 13, the trigger frame to instigate a second wireless transmission by the second STA and a third wireless transmission by the third STA, the second interference measurement based on the second wireless transmission and the third interference measurement based on the third wireless transmission.

17. At least one non-transitory computer-readable medium comprising a set of instructions that, in response to being executed at a wireless communication device, cause the wireless communication device to:
identify a frame received at a first station (STA) in a wireless transmission on a wireless channel, the frame comprising an indication of a subsequent transmission by a second STA on the wireless channel;
measure an interference caused by the subsequent transmission on the wireless channel; and
generate a frame for wireless transmission to an access point (AP), the frame to indicate the interference, a source of the interference, and a recipient of the interference.

18. The at least one non-transitory computer-readable medium of claim 17, the first STA to serve as a destination for a downlink (DL) transmission from the AP in a full duplex (FDX) communication with the second STA and the AP via the wireless channel.

19. The at least one non-transitory computer-readable medium of claim 17, the first STA to generate a frame for an uplink (UL) transmission to the AP in a full duplex (FDX) communication with the second STA and the AP via the wireless channel.

20. The at least one non-transitory computer-readable medium of claim 17, the second STA or the AP to send the frame received in the wireless transmission.

21. The at least one non-transitory computer-readable medium of claim 17, the frame received in the wireless transmission comprising a null data packet announcement (NDPA), a buffer status report (BSR) trigger frame (TF), a sounding TF, or a multi-user request to send (MU-RTS).

22. The at least one non-transitory computer-readable medium of claim 17, the subsequent transmission comprising a clear to send (CTS) frame, a buffer status report (BSR) frame, or a null data packet (NDP).

23. The at least one non-transitory computer-readable medium of claim 17, the frame generated for wireless transmission comprising a buffer status report (BSR) frame including an indication of a queue status of the first STA.

24. The at least one non-transitory computer-readable medium of claim 17, the frame generated for wireless transmission to indicate the first STA as the source of the interference and the second STA as the recipient of the interference.

25. The at least one non-transitory computer-readable medium of claim 17, the frame generated for wireless transmission to indicate the first STA as the recipient of the interference and the second STA as the source of the interference.
